(19) United States
(12) Patent Application Publication
(10) Pub. No.: US 2009/0025234 A1
(43) Pub. Date: Jan. 29, 2009

(54) FORM FITTING ELECTRIC SHAVER WITH MULTIPLE CUTTING ASSEMBLIES

(76) Inventor: VITO JAMES CARLUCCI, Stratford, CT (US)

Correspondence Address: Lawrence Cruz;Conair Corporation, One Cummings Point Road, STAMFORD, CT, 06902, US

(21) Appl. No.: 12/179,050

(22) Filed: Jul. 24, 2008

Related U.S. Application Data
(60) Provisional application No. 60/961,736, filed on Jul. 24, 2007.

(51) Int. Cl. B26B 21/02

(52) U.S. Cl. 30/527

(57) ABSTRACT

An apparatus for shaving a curved portion of the body, comprises an appliance body handle configured and dimensioned to be grasped by the hand of a user. Optionally, the support surface may define two planes with the shaving assembly lying in two planes and the planes being rotated with respect to each other with the rotation being along an axis extending in the direction of shaving. A support surface is disposed proximate to the appliance body handle, and it is secured to the appliance body handle. A first shaving member is floatingly mounted on the support surface at a first shaving member position and at a first shaving member angular orientation. A second shaving member is floatingly mounted on the support surface at a second shaving member position and at a second shaving member angular orientation.

### CROSS REFERENCE TO RELATED APPLICATIONS

This application claims the benefit of Provisional Patent Application No. 60/961,736, filed 24 Jul. 2007, the disclosure of which is hereby incorporated herein by reference.

### BACKGROUND OF THE INVENTION

1. Field of the Invention

The invention relates to personal-care appliances and, more particularly, to electric powered shaving devices for shaving hair on curved parts of the body and particularly well adapted for shaving the head.

2. Description of Related Art

Various electric powered shaving devices exist in different forms for shaving various parts of the body, some having special characteristics for particularly effectively shaving specific parts of the body. Most commercially manufactured electric shavers today have floating heads or a convex shaped foil or contact assembly for shaving contoured body parts such as the chin or the legs. These shavers generally have a shaving assembly with a flat base to which the floating heads or foils are mounted. This limits the ability of the shaver heads or foils to simultaneously cover a large surface area, when the surface to be shaved is convex, as is the case, for example, with the human scalp, particularly at the top of the head.

### OBJECTS OF THE PRESENT INVENTION

It is an object of the present invention to provide an electric shaving device which can, simultaneously and with comfort, relatively closely shave portions of a relatively large surface area on the body such as, but not limited to, the human head.

It is a further object of the present invention to accommodate the shaving of relatively rigid body portions with relatively small radii of curvature, such as the top of the human head. Shaving such body portions poses a particular challenge due to the substantial absence of a layer of fat underneath the skin, making the stability of the shaver heads to move conform to the shape of the scalp particularly important in view of the inability of the scalp to conform in shape to the form of the shaver.

Still another object of the invention is to reduce the extent to which a shaver head needs to deviate from its unbiased position in order to accommodate relatively curved surface portions to be shaved.

Yet another object of the invention is to provide a shaver with a plurality of heads, at least two of the heads being mounted at positions which are substantially angularly displaced with respect to each other and are thus not in the same plane.

It is yet a further object of the invention to provide a shaver with a shaving head which may be removed and replaced with a replacement shaving head or a haircutting head.

These and other objects may be achieved by the present invention as appears more fully below.

### BRIEF SUMMARY OF THE PRESENT INVENTION

According to the present invention, an electric shaving device has a plurality of shaving foils mounted parallel to respective, for example, generally planar surfaces, where the surfaces are not parallel to each other. This presents an effective area to be shaved in a single stroke, as the plurality of foils are mounted, generally, at positions which allow them with a reasonable amount of angular deviation to be positioned tangentially to the curvature of the human head at different points across the length of the shaving head. Such positioning is accommodated by spring mounting the foils in an unbiased position which allows them to be biased into other positions by the application of pressure to the foils by the body part being shaved.

In accordance with this arrangement, two elongated, cylindrical foils may be deflected so that both are simultaneously in substantially close contact with at least a portion of the scalp, for example. The result is to present an effective area being shaved at a single time, as the plurality of foils are positioned generally tangentially to the curvature of the human head at different locations simultaneously.

Alternatively, a plurality of shaver heads such as circular shaver heads may be mounted to a concave spherical surface.

In accordance with a preferred embodiment of the invention the apparatus for shaving a curved portion of the body comprises an appliance body handle configured and dimensioned to be grasped by the hand of a user. Optionally, the support surface may define two planes with the shaving assembly lying in two planes and the planes being angularly offset with respect to each other and joined along an axis extending in the direction of shaving.

A support surface is disposed proximate to the appliance body handle, and it is secured to the appliance body handle. A first shaving member is floatingly mounted on the support surface at a first shaving member position and at a first shaving member angular orientation. A second shaving member is floatingly mounted on the support surface at a second shaving member position and at a second shaving member angular orientation. The second shaving member position is different from the first shaving member position, and the second shaving member angular orientation is different from the first shaving member angular orientation.

The support surface may comprise a first support surface portion having a first support surface position and a first support surface angular orientation and a second support surface portion having a second support surface position and a second angular orientation. The second support surface angular orientation differs from the first support surface angular orientation.

The first and second shaving members may be elongated and have a length and a width, the first shaving member being oriented with a first perpendicular to its length being parallel to a second perpendicular to the length of the second shaving member, the first and second perpendiculars defining a functional tangential direction of movement during use of the apparatus for shaving a curved portion of the body.

The first and second shaving members may be elongated and shorter in length than the width of the support surface, the first and second shaving members being mounted on opposite ends of the support surface.

The first and second shaving members may assume angular positions with respect to each other between a first value in the range between 155° and 168°, and a second value in the range between 175° and 179°.

The first and second shaving members may assume angular positions with respect to each other between a first value in the range between 160° and 164°, and a second value in the range between 176° and 178°.

The first and second shaving members may assume angular positions with respect to each other between a first value of approximately 162°, and a second value of approximately 177°.

The first and second shaving members may be round in shape.

The first and second shaving members may be cylindrical in shape.

The event to shave them a further comprise a plurality of rollers which are floatingly mounted on the support surface.

### BRIEF DESCRIPTION THE DRAWINGS

The operation of the invention will become apparent from the following description taken in conjunction with the drawings, in which:

FIG. 1A is a side view of a shaving device in accordance with the present invention before the application of force to the shaving foils;

FIG. 1B is a view along lines 1B-1B of FIG. 1A;

FIG. 2 is a schematic illustration of a cutting foil and cutting member;

FIG. 3A is a side view of a shaving device similar to that of FIG. 1A, but after the application of force to the shaving foils;

FIG. 3B is a top view along lines 3B-3B of FIG. 3A;

FIG. 4 is a schematic view of a role of mounting useful in the shaver of the present invention;

FIG. 5A is a side view of an alternative embodiment of the present invention showing the inventive razor before the application of force to the shaving foils;

FIG. 5B is a top view along lines 5B-5B of FIG. 5A;

FIGS. 6A and 6B are views similar to FIGS. 5A and 5B showing the inventive shaver after the application of force to the shaving foils;

FIG. 7 is a front view of an individual with the inventive shaver shaving a relatively curved portion of the skull;

FIG. 8 is a front view of an individual with the inventive shaver shaving a relatively flat portion of the skull;

FIG. 9 is a top view of an alternative embodiment of the shaving device constructed in accordance with the present invention, with the shaving head removed and a haircutting head inserted in its place;

FIG. 10 is a top view of a comb guide useful with the electric shaver of FIG. 9;

FIG. 11 is a front view of the embodiment of FIG. 9 along lines 11-11 of FIG. 9; and

FIG. 12 is a front view of the comb guide of FIG. 10 along lines 12-12 of FIG. 10.

### DESCRIPTION OF THE PREFERRED EMBODIMENTS OF THE INVENTION

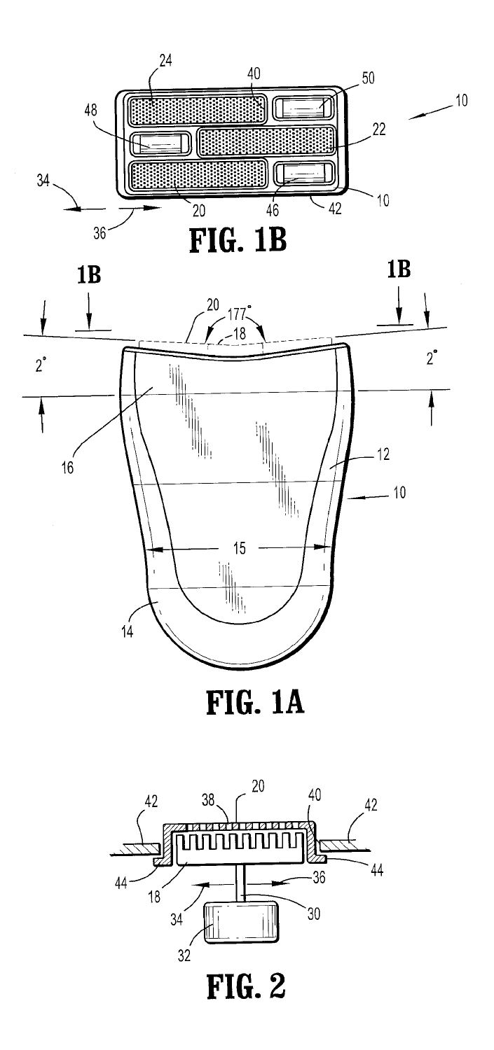

Referring to FIGS. 1A and 1B, a first embodiment of the present invention comprises an electric shaving device 10 which comprises a housing 12 with a handle portion 14. In accordance with a preferred embodiment, handle portion 14 on shaving device 10 is, optionally, of a smaller transverse dimension 15 as compared to head portion 16 to allow easy grasping of shaving device 10. In accordance with the preferred embodiment, handle portion 14 houses an electric motor, as well as drive components which are coupled to the electric motor. In accordance with a preferred embodiment, the motor is battery-powered, for example by a rechargeable battery.

The arrangement of the electric motor and drive components may be of any suitable type generally known in the art. Such subsystems may comprise an electric motor coupled to a cutting member 18, as illustrated in phantom lines in FIG. 1A. Cutting member 18 is positioned to bear against and conform to the shape of the inside surface of a conventional cutting foil 20. In the embodiment of FIGS. 1A and 1B, three cutting foils 20, 22 and 24 are provided. Each of these foils includes its own cutting member 18, 26 (not illustrated) and 28 (not illustrated). Such foils generally comprise a thin sheet of, optionally, curved metal plate with a plurality of holes in it.

During operation of such shavers, hairs are caused to enter into the holes to the point where the skin surrounding each hair pressingly engages the outside surface of the foil. The cutting member then passes across these holes, bearing against the hair shaft and driving it against the circumferential edge of the hole, thus shearing the hair shaft.

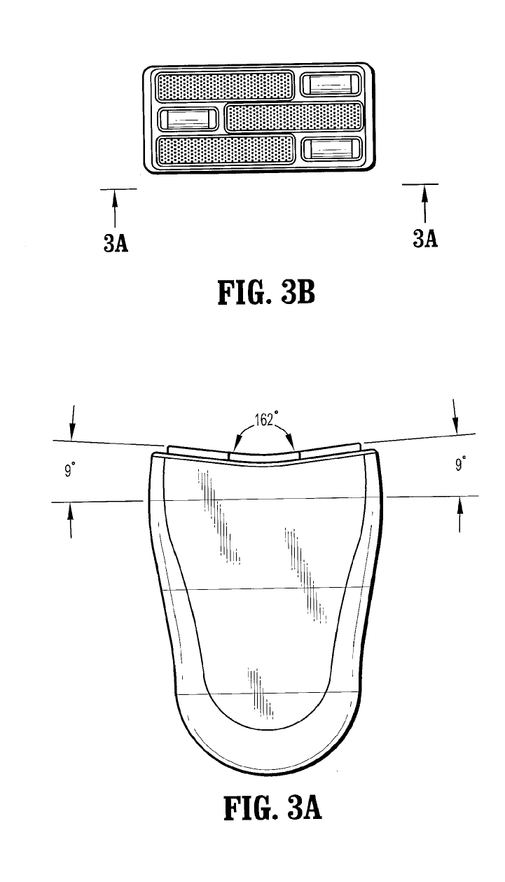

Foils 20, 22 and 24 are mounted for so-called “floating” movement. Any conventional mechanism for mounting foils with floating movement may be used. For example, each cutting member, such as cutting member 18, may be mounted on a flexible plastic shaft 30 which, in turn, is mounted on a motor 32 which vibrates the shaft in the direction of arrows 34-36, as illustrated in FIG. 2. When plastic shaft 30 is not subjected to any external force, the foils may have the positions illustrated in FIG. 3A. However, when subjected to forced, plastic shaft 30 will be deflected causing foil 20 to assume the configuration illustrated in FIG. 1A.

Foil 20 includes holes 38 whose circumferential edges act as blades to shear hair shafts. The range of motion of the foils is limited by mounting of foils 20-24 in elongated slots 40 in the head plate 42 of the shaving device 10. Elongated slots 42 do not constrain movement of the foils but conform relatively closely to the foils. The foils are prevented from falling off a shaver device 10 by a continuous circumferential lip 44, or alternatively by a plurality of lip members.

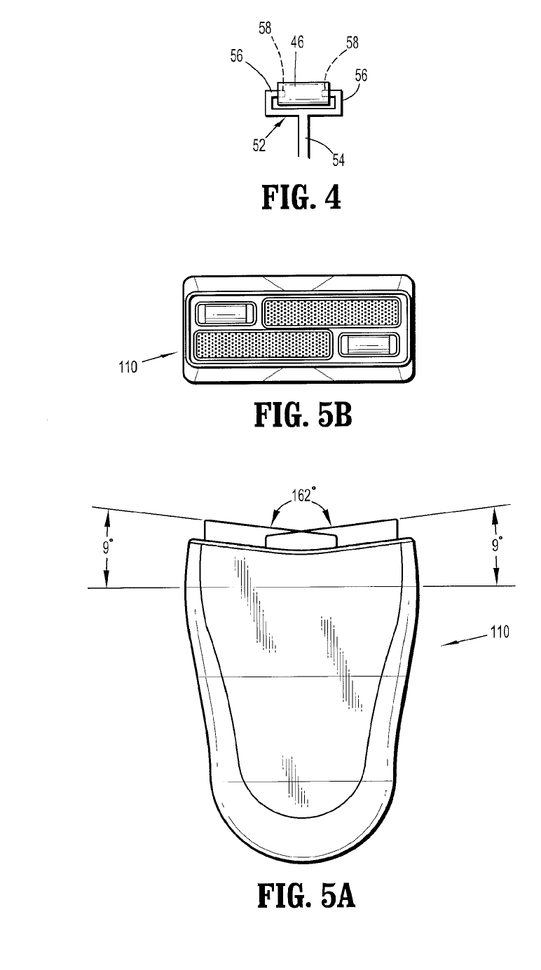

Use of the inventive shaver device is promoted by providing a plurality of rollers 46-50, which are also floatingly mounted. As illustrated in FIG. 4, rollers, such as roller 46 may be mounted on a flexible plastic support 52, comprising a flexible plastic rod portion 54, which may be integrally formed with a pair of spindle fingers 56, on which roller 46 turns freely. In accordance with a preferred embodiment, roller 46 may have a central bore which receives the tips 58 of fingers 56. In this manner, rollers 46-50, like foils 20-24 are free to move from the position illustrated in FIG. 1A to the position illustrated in FIG. 3A.

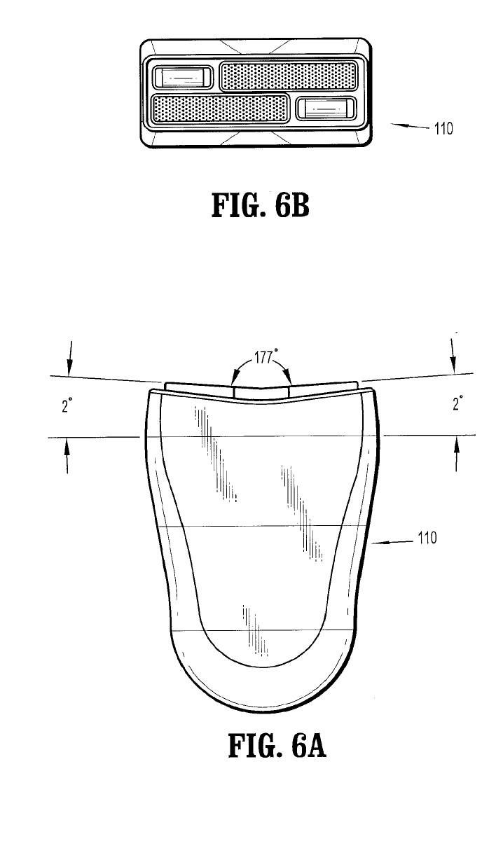

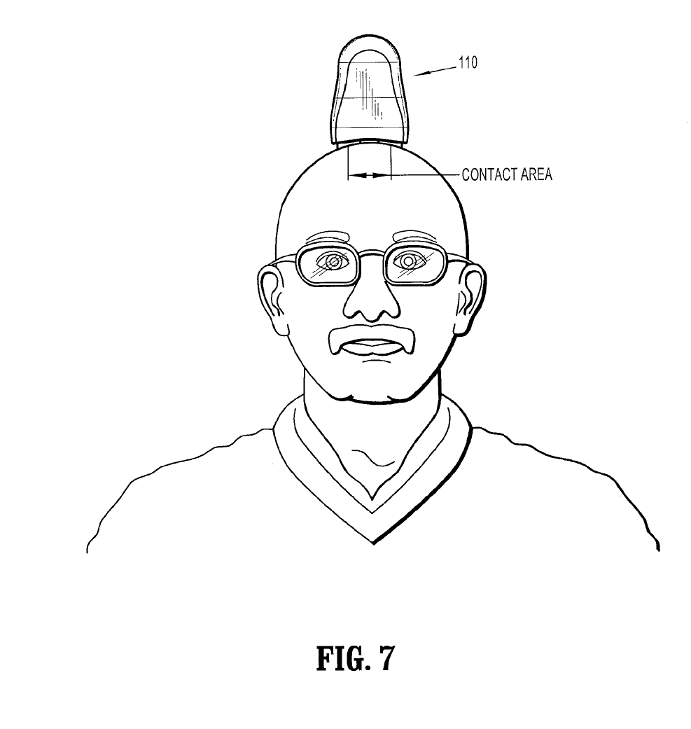

In accordance with the present invention it is also possible for a shaver 110 to be constructed with a pair of foils and a pair of rollers all of which are floatingly mounted, as illustrated in FIGS. 5A-B. Upon the application of pressure, the foils and rollers of the shaver 110 will move to the position illustrated in FIGS. 6A-B to accommodate use as shown in FIG. 7.

In accordance with the present invention, it has been found desirable for the relative positions of the two foils in the inventive shaver to move from positions where they have a range of movement from substantially flat (that is at an angle of 180° with respect to each other) to as little as 165° with respect to each other. One preferred range of movement is between 162° and 177°. In accordance with another embodiment of the invention, particularly suited for persons with smaller heads, such as children, a range of movement of relative positions of foils on opposite sides of the head of the shaver is between 155° and 177° is preferred.

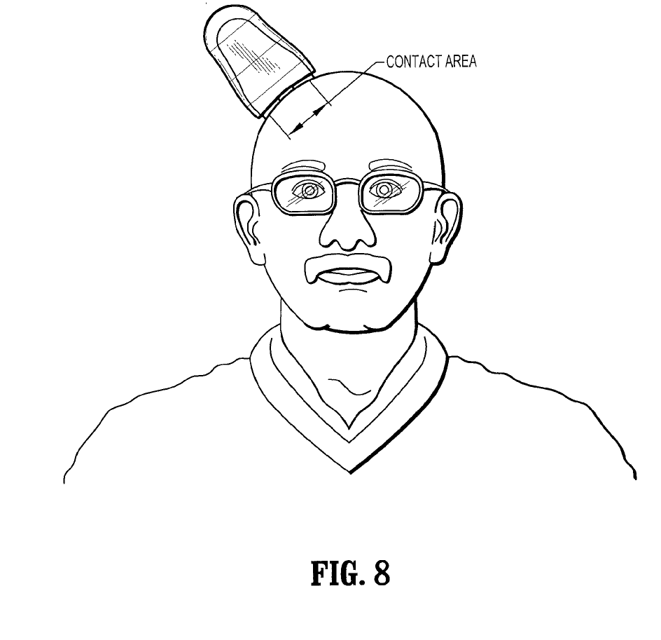

As a result, it is possible for the shaver to shave a relatively curved portion of the scalp, as illustrated in FIG. 7, as well as a relatively flat portion of the scalp, as illustrated in FIG. 8.

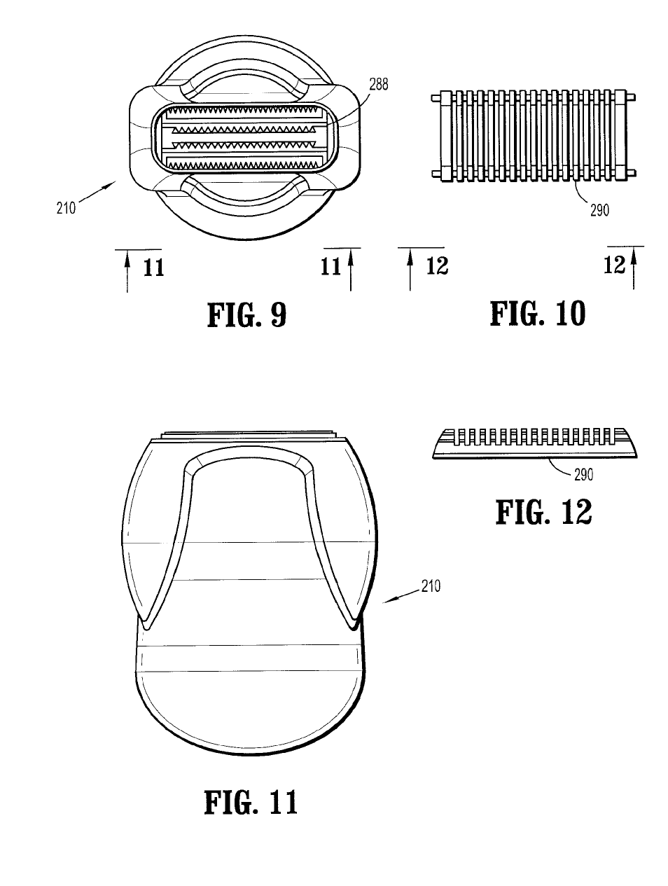

In accordance with the invention, it is contemplated that the plate 42 may be removed and the device fitted with another head, such as a hair cutting head meant to cut hair without shaving the same down to the skin. An electric shaving device 210 equipped with such a haircutting head 288 is illustrated in FIG. 9. Shaving device 210 may further comprise a comb guide 290 of conventional design, as illustrated in FIG. 10. Comb guide 290 is of the type which may be snapped in place or removed, as desired by the user. The structure of electric shaving device 210 and comb guide 290 may be more clearly understood with reference to FIGS. 11 and 12.

While illustrative embodiments of the invention have been described, it is understood that modifications of the same will be obvious to those of ordinary skill in the art. Such modifications are within the spirit and scope of the invention defined by the appended claims.

What is claimed:

1. Apparatus for shaving a curved portion of the body, comprising:
(a) an appliance body handle configured and dimensioned to be grasped by the hand of a user;
(b) a support surface disposed proximate to said appliance body handle, and secured to said appliance body handle;
(c) a first shaving member, said first shaving member being floatingly mounted on said support surface at a first shaving member position and at a first shaving member angular orientation; and
(d) a second shaving member, said second shaving member being floatingly mounted on said support surface at a second shaving member position and at a second shaving member angular orientation, said second shaving member position being different from said first shaving member position, and said second shaving member angular orientation being different from said first shaving member angular orientation.

2. Apparatus as in claim 1, wherein said support surface comprises:
(i) a first support surface portion having a first support surface position and a first support surface angular orientation;
(ii) a second support surface portion having a second support surface position and a second angular orientation, said second support surface angular orientation being different from said first support surface angular orientation.

3. Apparatus as in claim 1, wherein said first and second shaving members are elongated and have a length and a width, said first shaving member being oriented with a first perpendicular to its length being parallel to a second perpendicular to the length of said second shaving member, said first and second perpendiculars defining a functional tangential direction of movement during use of the apparatus for shaving a curved portion of the body.

4. Apparatus as in claim 1, wherein said first and second shaving members are elongated and shorter in length than the width of the support surface, said first and second shaving members being mounted on opposite ends of said support surface.

5. Apparatus as in claim 4, wherein said first and second shaving members may assume angular positions with respect to each other between a first value in the range between 155° and 168°, and a second value in the range between 175° and 179°.

6. Apparatus as in claim 4, wherein said first and second shaving members may assume angular positions with respect to each other between a first value in the range between 160° and 164°, and a second value in the range between 176° and 178°.

7. Apparatus as in claim 4, wherein said first and second shaving members may assume angular positions with respect to each other between a first value of approximately 162°, and a second value of approximately 177°.

8. Apparatus as in claim 1, wherein said support surface defines two planes, said shaving assembly lying in two planes, said planes being rotated with respect to each other, and said rotation being along an axis extending in the direction of shaving.

9. Apparatus as in claim 1, wherein said first and second shaving members are cylindrical in shape.

10. Apparatus as in claim 1 further comprising a plurality of rollers which are floatingly mounted on said support surface.
